(19) United States
(12) Patent Application Publication
(10) Pub. No.: US 2022/0295150 A1
(43) Pub. Date: Sep. 15, 2022

(54) IMAGE RECOMMENDATION FOR CONTENT PUBLISHING

(71) Applicant: Hewlett-Packard Development Company, L.P., Spring, TX (US)

(72) Inventors: Cassio Ruggeri Cons, Porto Alegre (BR); Nailson Boaz Costa Leite, Porto Alegre (BR); Fernando Friedrich, Porto Alegre (BR); Daniele Antunes Pinheiro, Porto Alegre (BR); Martin Jungblut Schreiner, Porto Alegre (BR); Alan Da Silva Aguirre, Porto Alegre (BR)

(73) Assignee: Hewlett-Packard Development Company, L.P., Spring, TX (US)

(21) Appl. No.: 17/635,398

(22) PCT Filed: Oct. 11, 2019
(86) PCT No.: PCT/US2019/055968

§ 371 Date: Feb. 15, 2022

(51) Int. Cl. H04N 21/466; G06F 16/58; G06F 16/951

(52) U.S. Cl. CPC H04N 21/4667; G06F 16/5866; G06F 16/951

(57) ABSTRACT

A system to output a recommended image for publication is provided. The system includes an image datastore to maintain images tagged with content tags and a content submission datastore to maintain a content submission. The system further includes a network interface to monitor a media feed containing trending metadata tags. The system further includes a controller to match a particular trending metadata tag to a particular image in the image datastore based on an opportunity score. The opportunity score based on at least similarity of a content tag of the particular image to the particular trending metadata tag, and an indication of popularity of the particular trending metadata tag. The controller is further to output the particular image as a recommended image to be used for publication with the content submission.

### BACKGROUND

Online media publishers are often interested in publishing content that is timely and relevant to current events. Such online media publishers may actively draft content and time the publication of content so that the content is received when the intended audience is primed and ready to engage with the content, thereby increasing consumption and traffic to the online media publisher.

Analytical tools are available to assist online media publishers to appropriately time and select content for publication based on feeds of online information. Such tools include features that enable a media publisher to schedule upcoming publications, to observe the dissemination of news stories and the discussion of topics on social media and elsewhere online, and to measure audience consumption of previously published content.

### BRIEF DESCRIPTION OF THE DRAWINGS

FIG. 1 is a schematic diagram of an example system to output a recommended image for publication.

FIG. 2A is a schematic diagram of an example data structure containing indications of popularity of trending topics and concepts that are related to trending topics.

FIG. 2B is a schematic diagram of another example system to output a recommended image for publication, the system including a controller ingesting trending metadata tags and available images and generating an opportunity score for a recommended image for publication.

FIG, 3 is a flowchart of an example method to output a recommended image for publication.

FIG. 4 is a flowchart of another example method to output a recommended image for publication.

FIG. 5 is a schematic diagram of another example system to output a recommended image for publication, the system including a user interface to receive a content submission and to receive a request for the content submission to be matched with a recommended image.

### DETAILED DESCRIPTION

Images play an important role in attracting consumption to online content. An image can be used to capture the attention of an audience in a crowded online media environment, and to drive traffic and advertising revenue toward the media publisher serving the content.

An online media publisher may enhance audience engagement with published content if the content includes an image that is relevant to a topic that is currently trending at the time of publication. However, attempting to generate and deliver content that is both timely and contains relevant engaging images may be prohibitively slow, cumbersome, and subject to significant guesswork. Using conventional tools, a media publisher may monitor current trends in online media, manually review the currently trending topics, select a topic, draft content related to the selected topic, search for a related image to include in the publication, and publish the content. Following this process, a media publisher is likely miss an opportunity to publish topically relevant and engaging content at the opportune time,

A system is described herein which generates recommendations for trending and topically-relevant images to be paired with content to be published based on data gathered from real-time media feeds. The system monitors media feeds to identify trending metadata tags, matches popular trending metadata tags with topically relevant images, and recommends to a media publisher to include an appropriate image in a publication that is aligned with a popular trending topic. In some use cases, the image may be selected from a pool of images that the media publisher wishes to consider for inclusion in content to be published when the media publisher actively requests a recommendation to be generated. In other use cases, the system may notify a media publisher when there is an opportunity to publish content with an associated image that is relevant to a currently trending topic. In either case, the selection of the image may be made with regard to an opportunity score which may account for similarity of the image to the trending topic, popularity of the trending topic, and similarity of the image to the content to be published.

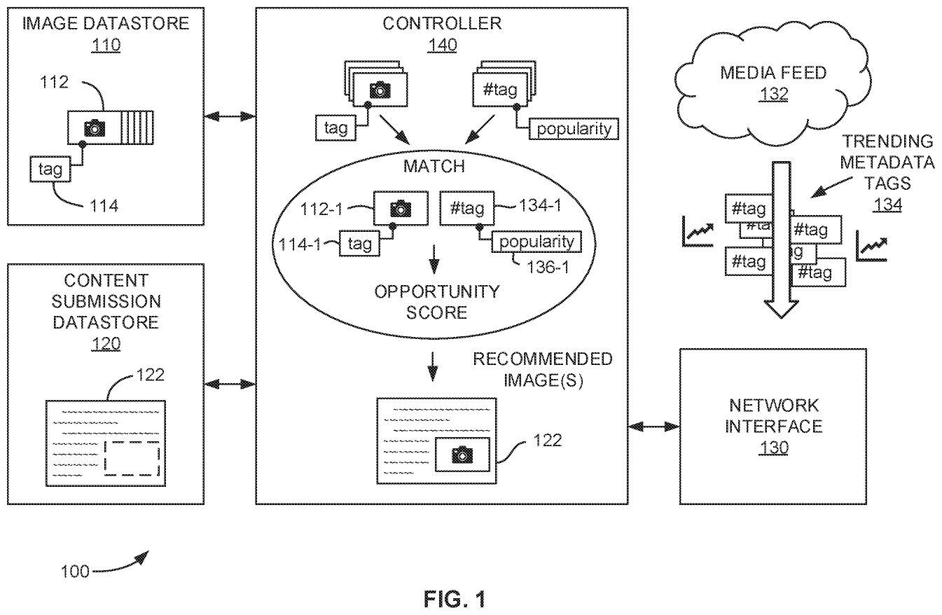

FIG. 1 is a schematic diagram of an example system 100 to output a recommended image for publication. The system 100 includes an image datastore 110 to maintain images 112 tagged with content tags 114. The images 112 may be stored in a folder on a media publisher's computer system, on a server, or in a media publishing application. Thus, the image datastore 110 may include volatile or non-volatile storage, such as one or more hard drives, random-access memory, or cloud computing storage. The image datastore 110 may contain images 112 that have been selected by a media publisher to be relevant to a particular piece of content to be published.

The system 100 further includes a content submission datastore 120 to maintain a content submission 122. The content submission 122 may be stored in a folder on a media publisher's computer system, on a server, or in a media publishing application. Thus, the content submission datastore 120 may include volatile or non-volatile storage, such as one or more hard drives, random-access memory, or cloud computing storage. The content submission 122 may refer to a piece of content to be published that the media publisher is considering to publish along with a timely and relevant image selected from the image datastore 110.

The system 100 further includes a network interface 130. The network interface 130 includes one or more processor and memory to execute the methods described herein which may be embodied in non-transitory machine-readable storage media. In particular, the network interface 130 is to monitor a media feed 132 containing metadata tags 134 that are trending. The media feed 132 may include an Application Programming Interface (API) of one or more social media platforms or other media feeds. The media feed 132 may contain actual posts and news stories published by social media or other media platforms that are tagged with metadata tags 134 (e.g, hashtags) that indicate the topics related to such posts and stories. The media feed 132 may also contain analytical data measuring the popularity of such topics through measures such as the number of recent posts or stories which include certain metadata tags 134, or the number of reads or other acts of user engagement with posts or stories which include a certain metadata tag 134.

The network interface 130 ingests such data for processing by a controller 140. The controller 140 includes one or more processor and memory to execute the methods described herein which may be embodied in non-transitory machine-readable storage media. In particular, the controller 140 is to match a particular metadata tag 134-1 to a particular image 112-1 in the image datastore 110 based on an opportunity score.

An opportunity score provides a measure of the timeliness and relevance of the particular image 112-1 a particular metadata tag 134-1. An opportunity score is based at least on the similarity of a particular content tag 114-1 of the particular image 112-1 to a topic represented by the particular metadata tag 134-1, and an indication 136-1 of popularity of the particular metadata tag 134-1.

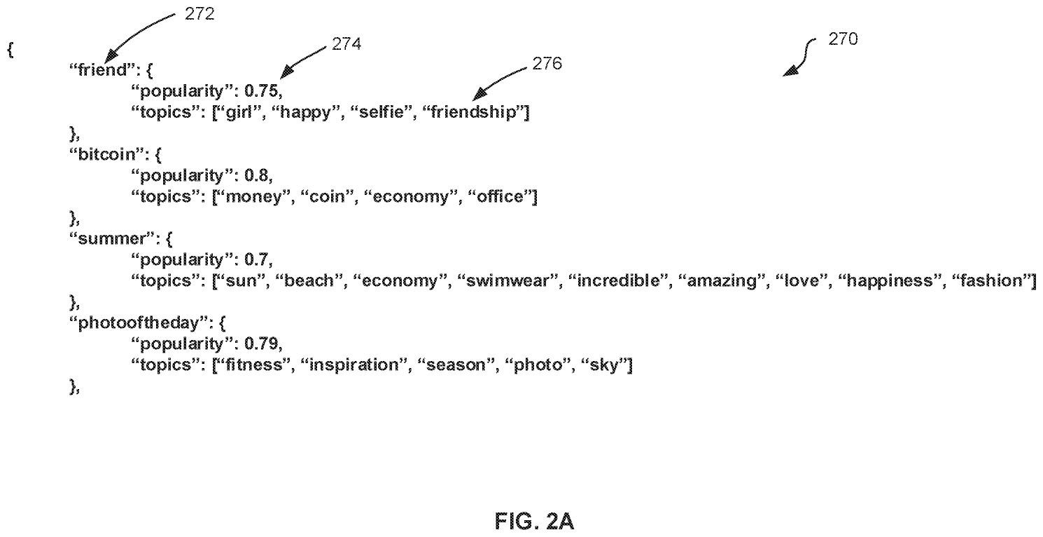

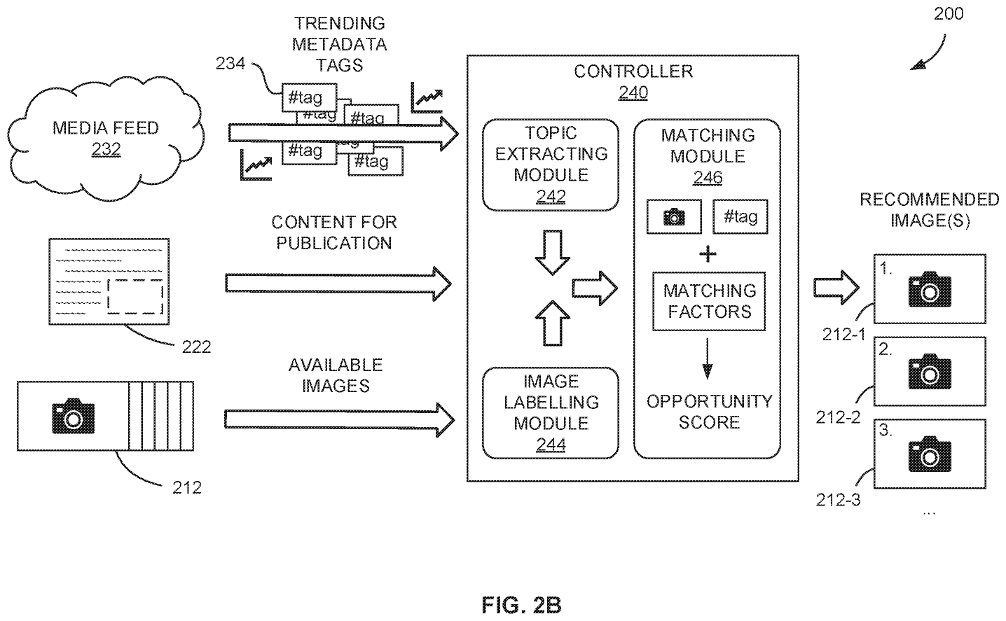

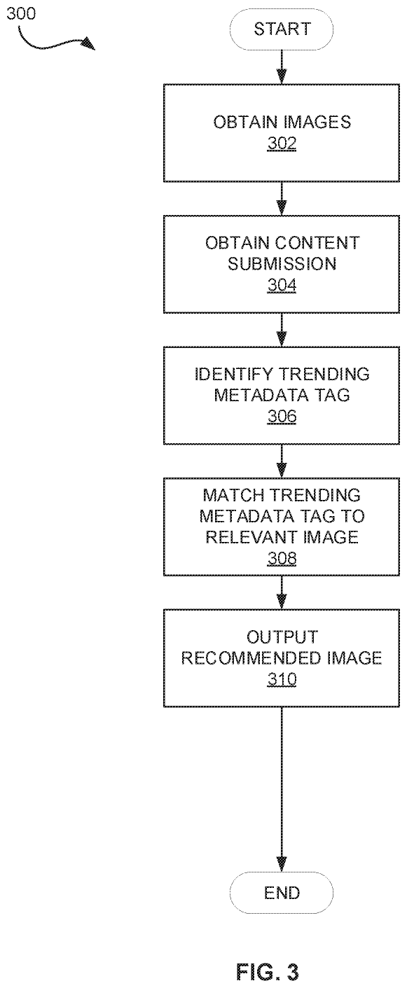

Determining the similarity of a particular content tag 114-1 of a particular image 112-1 to topic represented by a particular metadata tag 134-1 may involve natural language processing techniques for determining the “distance” between two topics. Further, since a particular metadata tag 134-1 may relate to multiple topics, the process may involve generating a list of topics which are similar to topics extracted from the particular metadata tag 134-1, as shown for example in FIG. 2A. FIG. 2A shows a data structure 270 which include a data entry 272 for the topic “friend” that has been extracted from a particular trending metadata tag. The data entry 272 includes an indication 274 of popularity of the topic “friend” (e.g. a real number between 0 and 1), and further includes a list 276 of topics similar to the topic of “friend”, including the words “girl”, “happy”, “selfie”, and “friendship”. Such data entries may be generated by natural language processing techniques which suggest related topics that are within a threshold distance from a target topic extracted from the particular metadata tag 134-1. Calculation of an opportunity score is discussed in greater detail below with respect to FIG. 2B.

Returning to FIG. 1, the controller 140 is also to output the particular image 112-1 as a recommended image to be used for publication with the content submission 122. The controller 140 may output a single particular image 112-1 or a ranking of multiple images having high opportunity scores to be selected by the media publisher. Thus, outputting the particular image 112-1 as the recommended image may involve outputting a ranking of recommended images, wherein the ranking includes the particular image. A threshold opportunity score may be used to determine whether an image is presented to the media publisher as a potential match.

Further, in some examples, the controller 140 may also output a recommended metadata tag to be associated with the publication, which may be similar to or the same as the particular metadata tag 134-1.

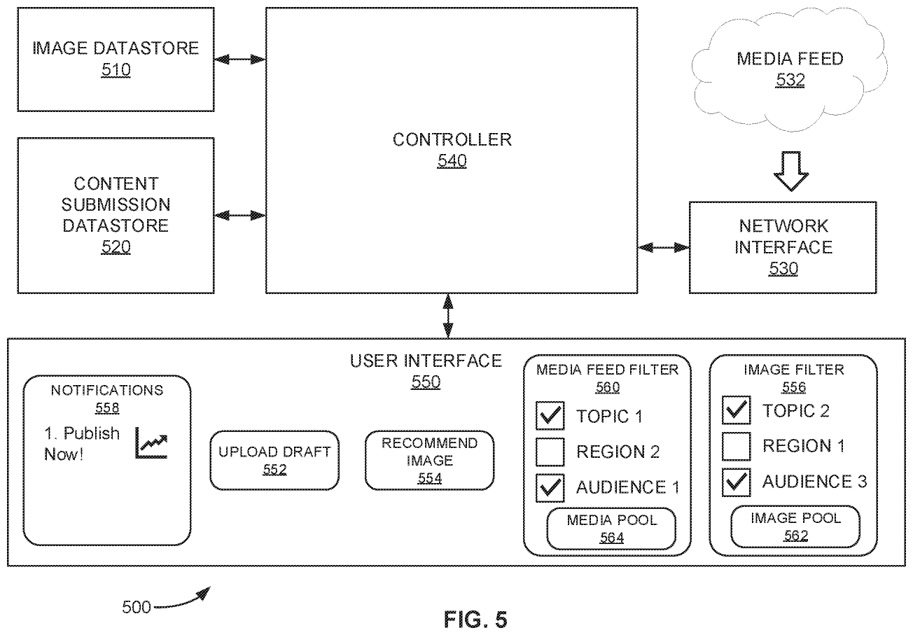

The recommended image, and in some examples, the recommended metadata tag, may be presented to a media publisher using the system 100 through a user interface on a mobile application, website, a screen-equipped smart speaker, or any other audio or visual notification. A user interface for the media publisher to interact with is described in greater detail below with respect to FIG. 5.

FIG. 2B is a schematic diagram of another example system 200 to output a recommended image for publication. The system 200 is similar to the system 100 of FIG. 1, with like elements numbered in the “200” series rather than the “100” series, and with certain elements omitted for brevity. The system 200 includes a controller 240, media feed 232, images 212, content submission 222, and metadata tags 234, which may be similar to like elements described with respect to FIG. 1. For further description of these elements, reference to the description of the system 100 of FIG. 1 may be had.

Shown in FIG. 2B, the controller 240 ingests metadata tags 234 that are trending and available images 212 and generates an opportunity score for pairs of images and metadata tags based on matching factors, and selects a recommended image or images. FIG. 2B shows certain functional modules of the controller 240, including a topic extracting module 242, image labelling module 244, and matching module 246, discussed in greater detail herein.

The topic extracting module 242 is to extract topics from metadata tags 234. The topic extracting module 242 may apply natural language processing techniques to extract topics represented by metadata tags 234. The natural language processing techniques may involve word embedding techniques to retrieve concepts represented by each metadata tag by analyzing a larger corpus of publications made on a media platform.

The image labelling module 244 is to label images 212 with content tags that provide information about the images 212. The image labelling module 244 analyzes and identifies the contents of each image 212 and suggests or labels each image 212 with keywords related to the content of each image 212. Thus, the image labelling module 244 may apply a machine vision technique to generate content tags for the images 212.

The matching module 246 is to calculate an opportunity score between an image 212 and a metadata tag 234 based on one or more matching factors to provide a measure of the opportunity to publish a timely and relevant image. The matching factors may include, as discussed above with respect to FIG. 1, similarity of a content tag of an image 212 to a topic represented by a metadata tag 234, and an indication of popularity of a metadata tag. Further, the matching factors may include similarity of a content tag of an image 212 to text content contained in a content submission 222. Any combination of these matching factors may be used. Thus, the system 200 may provide a recommendation for an image 212 that is not only timely and relevant to a currently trending topic, but that is also relevant to content to be published.

The opportunity score may be calculated by a weighted combination of such matching factors. For example, an opportunity score of a particular image-metadata tag pairing may be calculated as Opportunity Score=(weight_1*image_similarity_to_trend weight_2*popularity_of_trend+weight_3*image_similarity_to_content), where weight_1, weight_2, and weight_3 are weighting factors from 0 to 1. The “image_similarity_to_trend” factor is a measure of similarity between one or more content tags of an image 212 and one or more topics extracted from a metadata tag 234. The “popularity_of_trend” factor is a measure of the popularity or trendiness of a metadata tag 234. The “image_similarity_to_content” factor is a measure of similarity between one or more content tags of an image 122 and text contained in the content submission 222.

Where an image 212 is tagged with multiple content tags, or when a metadata tag 234 is associated with multiple topics, various algorithms may be used to generate an overall opportunity score between the image 212 and the metadata tag 234. In some examples, an algorithm may calculate a specific opportunity score as between each pair of topics, and calculate an average each of the pairings, to generate an overall opportunity score. In other examples, an algorithm may consider only the pairing of topics which leads to calculation of the highest opportunity score, and assigns that highest opportunity score as the overall opportunity score between the image 212 and metadata tag 234.

Ultimately, the controller 240 outputs a recommended image or ranked list of images (e.g. images 212-1, 212-2, 212-3) to be selected by a media publisher for use with the content submission 222. A threshold opportunity score may be used to determine whether an image is presented to the media publisher as recommended image in the ranking.

FIG. 3 is a flowchart of an example method 300 to output a recommended image for publication. All or part of the method 300 may be may be instantiated in instructions stored on a non-transitory machine-readable storage medium and executed by a device or system discussed herein, such as the controller 140 of FIG. 1 discussed above, the controller 240 of FIG. 2 discussed above, or the controller 540 of FIG. 5 discussed below. However, this is not limiting, and the method 300 may be executed by other devices or systems.

At block 302, a set of images tagged with content tags is obtained. At block 304, a content submission is obtained. At block 306, a trending metadata tag is identified. At block 308, the trending metadata tag is matched to a relevant image from the set of images based on an opportunity score. The opportunity score is based on at least similarity of a content tag of the relevant image to the trending metadata tag, and an indication of popularity of the trending metadata tag.

The trending metadata tag may be matched to the relevant image by extracting topics from the trending metadata tag, calculating an opportunity score for a plurality of combinations of images and metadata tags, identifying a particular image and a particular metadata tag of the plurality of combinations that results in a highest opportunity score, and selecting the particular image as the recommended image to be used for publication with the content submission. Finally, at block 310, the relevant image is output as a recommended image to be used for publication with the content submission.

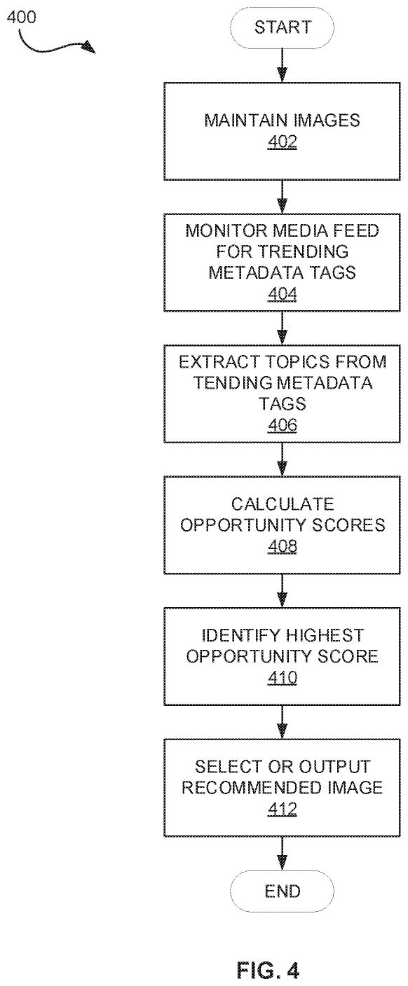

FIG. 4 is a flowchart of another example method 400 to output a recommended image for publication. All or part of the method 400 may be may be instantiated in instructions stored on a non-transitory machine-readable storage medium and executed by a device or system discussed herein, such as the controller 140 of FIG. 1 discussed above, the controller 240 of FIG. 2 discussed above, or the controller 540 of FIG. 5 discussed below. However, this is not limiting, and the method 400 may be executed by other devices or systems.

At block 402, images tagged with content tags are maintained. At block 404, a media feed is monitored to identify trending metadata tags. At block 406, topics from the trending metadata tags are extracted. At block 408, an opportunity score is calculated for each image with respect to each trending metadata tag.

Each opportunity score is based at least on similarity between a content tag with which a respective image is tagged and a topic extracted from a respective metadata tag. The opportunity score of each respective image to each respective metadata tag may be based on a combination of similarity between a content tag with which the respective image is tagged and a topic extracted from the respective metadata tag, and an indication of popularity of the respective metadata tag. In some examples, the matching may further involve matching the particular image with a content submission to be published based on topical relevancy of the particular image to text content in the content submission.

The matching may be preceded or followed by filtering one or more of the content tags of the images or the topics from the trending metadata tags so that the media publisher may narrow the audience and/or topics covered. That is, the method 400 may involve filtering content tags of the images based on one or more of: topic, region, and audience characteristic, and further, the method 400 may involve filtering the trending metadata tags based on one or more of: topic, region, and audience characteristic.

At block 410, a particular image and a particular metadata tag that results in a highest opportunity score are identified. At block 412, the particular image is output as a recommended image to be used for a publication, Further, the method 400 may involve embedding the particular image into a content submission to be published, and outputting the content submission for publication.

FIG. 5 is a schematic diagram of another example system 500 to output a recommended image for publication. The system 500 may be similar to the system 100 of FIG. 1, with like elements numbered in a “500” series rather than a “100” series, and thus, may include an image data store 510, content submission datastore 520, network interface 530, media feed 532, and controller 540. For further description of the above elements, the description of the system 100 of FIG. 1 may be referenced.

The system 500 further includes a user interface 550. The user interface 550 may include a content submission interface 552 to receive a content submission to be published. That is, the content submission interface 552 may enable a media publisher to draft or upload a draft of content to be published. The content submission interface 552 may include a button to upload, select, or link to, a pre-written document containing the content submission, or may include a word processing interface to enable the media publisher to draft the content submission in the user interface 550.

The user interface 550 may further include a recommendation request interface 554 to receive a request for the content submission to be matched with the recommended image. That is, the recommendation request interface 554 may enable a media publisher to request that the content submission be matched with an image that is relevant to a currently trending topic. In turn, the controller may match a metadata tag to an image in response to the request.

The user interface 550 may further include an image filter interface 556 to configure an image filter to filter the content tags of the images. The image filter interface 556 may be enable a media publisher to filter an image pool based on topic, region, audience characteristic, or other criteria. The image filter interface 556 may include functionality to select a particular folder or network path from which the pool of images is to be selected, as shown by the image pool selection interface 562. When an image filter is configured, the controller 540 may apply the image filter to the image datastore 110.

The user interface 550 may further include a notification interface 558 to generate notifications for the media publisher to solicit a request to publish the content submission. Thus, a media publisher may be kept notified of whether a particular topic is trending for which a relevant content submission may be made.

The user interface 550 may further include a media feed filter interface 560 to configure a media filter to filter topics of metadata tags from the media feed. Topics may be filtered by topic, region, user age, or other audience characteristic that a media publisher may wish to use to target a particular audience. For example, metadata tags covering topics relating only to “photography” or similar concepts may be considered by the controller 540 in matching metadata tags to images. The media feed filter interface 560 may include functionality to select a particular media platform, social media platform, or media feed, and the like, from which trending metadata tags are to be monitored, as shown by the media pool selection interface 564.

When used in combination with the image filter interface 556 or media feed filter interface 560, the notification interface 558 may provide monitoring of only those topics in which a media publisher is interested, and notify the media publisher when topics related to the images held by the media publisher are trending.

Thus, it can be seen that a system to automatically recommend images to be published with timely and relevant content may be provided. Such a system may enabler a media publisher to keep up-to-date with media trends without active monitoring, automates a portion of the publication process to allow for more timely publication of content, and improves the reach of newly posted content by leveraging the popularity of currently trending topics.

It should be recognized that features and aspects of the various examples provided above can be combined into further examples that also fall within the scope of the present disclosure. The scope of the claims should not be limited by the above examples but should be given the broadest interpretation consistent with the description as a whole,

1. A method to output a recommended image for publication, the method comprising:
maintaining images tagged with content tags;
monitoring a media feed to identify trending metadata tags;
extracting topics from the trending metadata tags;
calculating an opportunity score for each image with respect to each trending metadata tag, each opportunity score based at least on similarity between a content tag with which a respective image is tagged and a topic extracted from a respective metadata tag;
identifying a particular image and a particular metadata tag that results in a highest opportunity score; and
outputting the particular image as a recommended image to be used for a publication,

2. The method of claim 1, wherein the opportunity score of each respective image to each respective metadata tag is based on a combination of:
similarity between a content tag with which the respective image is tagged and a topic extracted from the respective metadata tag; and
an indication of popularity of the respective metadata tag.

3. The method of claim 1, further comprising:
embedding the particular image into a content submission to be published; and
outputting the content submission for publication.

4. The method of claim 1, further comprising matching the particular image with a content submission to be published, the matching based on topical relevancy of the particular image to text content in the content submission.

5. The method of claim 1, wherein the method further comprises filtering the trending metadata tags or the content tags of the images based on one or more of: topic, region, and audience characteristic,

6. The method of claim 1, wherein outputting the particular image as the recommended image comprises outputting a ranking of recommended images, wherein the ranking includes the particular image.

7. The method of claim 1, further comprising selecting a particular trending metadata tag as a recommended metadata tag to be associated with the publication.

8. A system to output a recommended image for publication, the system comprising:
an image datastore to maintain images tagged with content tags;
a content submission datastore to maintain a content submission;
a network interface to monitor a media feed containing trending metadata tags; and
a controller to:
match a particular trending metadata tag to a particular image in the image datastore based on an opportunity score, the opportunity score based on at least:
similarity of a content tag of the particular image to the particular trending metadata tag, and
an indication of popularity of the particular trending metadata tag; and
output the particular image as a recommended image to be used for publication with the content submission.

9. The system of claim 8, wherein the opportunity score is based on a combination of:
similarity of a content tag of the particular image to the particular trending metadata tag,
an indication of popularity of the particular trending metadata tag, and
similarity of the content tag of the particular image to text content contained in the content submission.

10. The system of claim 8, wherein:
the system further comprises a user interface to:
receive the content submission; and
receive a request for the content submission to be matched with the recommended image; and
the controller is to match the particular rending metadata tag to the particular image in response to the request.

11. The system of claim 10, wherein:
the user interface is to configure an image filter to filter the content tags of the images based on one or more of: topic, region, and audience characteristic; and
the controller is to apply the image filter to the image datastore.

12. The system of claim 8, wherein the controller is further to generate a notification to solicit a request to publish the content submission.

13. The system of claim 8, wherein the controller is further to apply a machine vision technique to generate content tags for the images.

14. A non-transitory machine-readable storage medium comprising instructions that when executed cause a processor to:
obtain a set of images tagged with content tags;
obtain a content submission;
identify a trending metadata tag;
match the trending metadata tag to a relevant image from the set of images based on an opportunity score, the opportunity score based on at least similarity of a content tag of the relevant image to the trending metadata tag, and an indication of popularity of the trending metadata tag; and
output the relevant image as a recommended image to be used for publication with the content submission.

15. The non-transitory machine-readable storage medium of claim 14, wherein the instructions further cause the processor to match the trending metadata tag to the relevant image by:
extracting topics from the trending metadata tags;
calculating an opportunity score for a plurality of combinations of images and metadata tags;
identifying a particular image and a particular metadata tag of the plurality of combinations that results in a highest opportunity score; and
selecting the particular image as the recommended image to be used for publication with the content submission.
